(19) United States
(12) Patent Application Publication
(10) Pub. No.: US 2008/0070522 A1
(43) Pub. Date: Mar. 20, 2008

(54) Messaging System and Techniques Using RDS/RBDS

(75) Inventors: William S. Marriott, Indialantic, FL (US); Ove Kammentz, Joldelund (DE)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: viaRadio Corporation, Melbourne, FL (US)

(21) Appl. No.: 11/697,037

(22) Filed: Apr. 5, 2007

Related U.S. Application Data
(60) Provisional application No. 60/825,604, filed on Sep. 14, 2006.

(51) Int. Cl. H04H 1/00; H04B 1/18

(52) U.S. Cl. 455/150.1; 340/7.26; 370/312; 455/503

(57) ABSTRACT

The functionality associated with an RDS/RBDS messaging system is enhanced by allowing users of the system access to a secure server which gives them the ability to manage the user address space, to compose custom and preformatted messages and to access CAP files that might contain information affecting users in the area of an FM transmitter sending alert messages. The alert messages are sent to the RDS/RBDS encoder as ODA data groups using a developed protocol. Standard alert radios are modified to utilize the functionality of the system. The system will also send back up alerts to a users cellular telephone and to specified email, SMS and text messaging destinations.

### CROSS REFERENCE TO RELATED APPLICATIONS

This application is related to and claims priority to provisional patent application 60/825,604, filed Sep. 14, 2006, entitled A Broadcast Messaging System Using Broadcast FM Radio As The Delivery Medium Where A Custom Sub Protocol Of The RBDS Subcarrier Is Used To Send Messages And Commands To Custom Remote Radio Devices by inventor William Marriott which is incorporated by reference herein in its entirety.

### BACKGROUND OF THE INVENTION

1. Field of the Invention

The invention relates to messaging systems and more particularly to improved messaging systems using RDS/RBDS.

2. Description of the Prior Art

A number of U.S. patents refer to RDS/RBDS systems and techniques.

U.S. Pat. Nos. 6,625,464 and 6,909,357 to Bandy et al. describe an RBDS receiver, which is user programmable to select some of the messages transmitted.

U.S. Pat. No. 6,411,800 to Emerson, III, shows a modified RBDS protocol which provides a capability for broadcasters to identify themselves both by their program format as well as by the announcements they carry.

U.S. Pat. No. 6,829,475 to Lee et al. combines Global Positioning Satellite information (GPS) with AM/FM/TV/Satellite sources including RDS/RBDS.

U.S. Pat. No. 5,457,815 to Morewitz, II, describes an RBDS system which utilizes dual tuners.

The Radio Data Systems (RDS) was developed in Germany in the 1980s as an outgrowth of a traffic alerting system. It is widespread throughout Europe, and was introduced into the United States in 1993 where it is known as Radio Broadcast Data System (RBDS). In 1997, numerous automakers introduced RDS radios in the United States. RDS uses a low data rate digital subcarrier at 57 kHz to transmit data such as a station's call letters or program type (Jazz, etc.) along with the main FM radio signal. The data rate is 1187.5 bits per second, equivalent to a 1200 baud modem, although after overhead and mandatory protocol elements are accounted for the remaining data rate available to applications is about 300 bits per second. There is also a provision for sending 32 or 64 character text messages, referred to as “Radio Text”. The data is typically displayed on a small monochrome text screen mounted on the radio's face. Most commonly, this screen is 8 characters long, and Radio Text messages are scrolled across the screen to present the entire message. A number of different program types and services are specified by the RDS/RBDS standards.

The RBDS standard was created and published by the National Radio Systems Committee (NRSC), formed jointly by the National Association of Broadcasters (NAB) and the Consumer Electronics Manufacturers Association (CEMA), a division of the Electronics Industry Association (EIA). The RBDS standard is a derivative of the RDS standard published by the European Broadcasting Union, headquartered in Geneva, Switzerland, as CENELEC EN50067. The single acronym RDS will be used hereinafter to apply to both the RDS and the RBDS standards.

The new “RDS IEC 62106:1999 Standard” approved by the RDS forum (www.rds.org.uk) is hereby incorporated by reference into this specification in its entireties. The corresponding standard for the “United States known as the United States RBDS Standard of Apr. 9, 1998” is hereby also incorporated by reference in its entirety. The latter standard was developed by a joint project of the Electronics Industries Association and the National Association of Broadcasters. In addition, the “RDS Universal Encoder Communication Protocol UECP version 5.1” published by the European Broadcasting Union and the RDS forum (August, 1997—SPB 490 (5^{th} revision)) is also hereby incorporated by reference by its entirety.

### The RDS Service (Radio Data System)

The Radio Data System (RDS) is an add-on data service, used by many 87.5 to 108 MHz FM radio stations. The purpose of RDS is to increase the system functionality.

### RDS Features

RDS systems contain a number of features.

### Alternate Frequency (AF/EON)

This function helps prevent car drivers from having to manually change the frequency while driving. If the chosen signal turns weak, the RDS tuner automatically switches to an alternative frequency. This works by a list of alternative frequencies, which is transmitted via RDS. The tuner automatically switches to the strongest station. To avoid user inconvenience, the tuner is muted during fast automatic switching.

### Traffic Announcement/Traffic Program Indication (TA/TP)

This function can be used to mark a station that offers traffic information (TP) and to indicate if there is ongoing traffic information. An RDS tuner can be set to only unmute audio if there is ongoing traffic information (TA).

### TMC—Traffic Information via Traffic Message Channel

Can be used to forward special traffic information. This could be information about traffic jams, which are used by navigation systems for optimized routing.

### Station Name, Program Type, Radio Text (PS/PTY/PTYN/RT)

RDS tuners can display the station name (PS) instead of the frequency or display program related information (PTY/PTYN). Radio text makes it possible to broadcast longer text blocks like the song title and the artist of the current song.

### Specific User Data Forwarding (TDC)

Can be used to forward any transparent data via RDS.

### Radio Paging (RP)—Paging via RDS

RDS offers pager capability. Specific pagers can receive individual messages via RP.

### EWS—Emergency Warning System

EWS Emergency Warning

RDS has a fomant code that will trigger all listening radios, causing them to dispaly “Alert” or similar and typically beep in some manner

### Problems with the Prior Art

Significant problems with the existing RDS/RBDS systems include the fact that they are normally utilized for a very limited set of functionality. They tend to be utilized for the traditional functionality of providing traffic information, station information, user data forwarding, radio paging and as an emergency warning system. However, each of those uses is very restricted in its functionality and its capabilities that it provides to users of the system.

FIG. 1 is a block diagram of a typical RDS encoding system of the prior art. An FM transmitter comprising an exciter 100 in a power amplifier 110 drive provide a strong signal to antenna 120 for transmission to the surrounding broadcast area. The program material to be transmitted over the FM transmitter comprises program information 130 originated by the station and RDS information which arrives over a communications link 140, (which may be a local or a remote communications link) the program material is fed to an RDS encoder 150 and applied to the exciter 100 of the FM transmitter.

FIG. 2 illustrates spectrum utilization of an FM transmitter using RDS. The lower 15 Kz contains the monophonic audio signal. The stereo audio signal is placed between 23 and 53 Kz. The RDS data is contained in side bands at 57 Kz as illustrated. The RDS technology enables data rates of about 1187 bits per second.

FIG. 3 is a block diagram of a prior art early warning system using RDS.

An FM transmitter with RDS 300 transmits an early warning alert which is received on an RDS channel of the public early warning receiver 310. Such emergency warning systems are typically used in the vicinity of high-risk activities such as nuclear power plants. Typically, the public early warning receivers 310 are dedicated devices which only announce an alert on the rare occasions when an alert actually occurs. This creates a problem in that real alerts do not occur very often and so the receivers in homes near to the nuclear power plant don't go off very often. They take up space in the home and eventually, the homeowner determines that the receivers are useless since they are not used. Therefore, the receivers get put away the batteries discharge and they are simply not used. This, of course, defeats the purpose of the early warning system.

### BRIEF SUMMARY OF THE INVENTION

By updating the capabilities of a simple triggerable clockradio to support text messaging to multiple address groups at multiple alert levels, designing a server that allows various users to initiate or create certain messages based on their security rights, and designing a new protocol to convey this information to the radios, a messaging system has been created that extends beyond just emergency messaging support other messaging such as community event messaging or subscription services such as locally customizable traffic messaging or custom weather.

The wireless medium is the RBDS data subcarrier of broadcast FM radio. The inventor uses the Open Data Applications (ODA) component of the RBDS to send commands and messaging using a custom protocol to custom remote radio devices.

A web server validates and accepts remote connections from system users by communicating with the database. Each user is associated with a customer number and a UserGroup. When logged on, the user is presented with messaging choices served up by the database. These choices may include:
1. Fully custom messaging—ie user can compose any message to any defined destination and send at any defined priority.
2. Prepared messages which are messages already composed, each with its own list of allowed destination choices and maximum priority.

Once chosen or composed, the text message is encrypted into the custom messaging protocol described hereinafter and sent to the appropriate RDS encoders for transmission over the FM station(s).

The text message is tagged with a message number, destination group, customer number and priority code.

All of the receivers in range of the FM signal hear the message but only those which have been preprogrammed as members of the destination group and customer number being broadcast respond, doing so in various ways including audible and visual alert, relay contact closure, serial data output and radio activation at various volume levels. The actual combination of these responses is preprogrammed in the radio for each of the eight priority levels.

The message will be repeated regularly until canceled by the user or the system but each radio will only activate once per message number.

The primary messaging interface is via the web. Users log on to a customer account as a member of a usergroup with additional rights on a per user basis. Some users can compose and send fully custom messages to any defined destination group for that customer.

Each usergroup can also send already composed “Prepared Messages” each having a message-specific list of destination choices and allowed priorities.

Certain high priority users can remotely configure the radios and perform user and system management for their customer account

Server automatically and periodically gathers Common Alerting Protocol (CAP) files from the Internet as specified by customer and then parses the files for matching keyword and event codes. If a match is found then a message to a specific destination group is generated. One source of CAP files is the National Weather Service.

One aspect of the invention utilizes a custom data protocol which rides within the open data (ODA) part of the RDS/RBDS subcarrier of broadcast FM stations.

Additional aspects of the invention involve enhancements to the receiver utilized to receive the RDS/RBDS transmissions. Those features include:
Using a new proprietary Open Data Applications (ODA) data protocol riding on the RBDS subcarrier.
Displaying text messages up to 720 characters.
Storing up to last 10 messages.
Individually addressed radios.
The radio filters repeated messages that have already been received allowing one to repeat messages to update or correct any bad or missing packets for reliable delivery without nuisance multiple activations.
The radios include programmable relay activation.
The radios include remotely programmable group address membership
The radios include remotely programmable radio actions for each message priority level.
The radios include remotely programmable serial text and data output.
The radio scans entire band on startup and remembers where all of our network stations are.
The radio can then automatically switch to alternate network station if primary station is lost.

### BRIEF DESCRIPTION OF THE DRAWINGS

The invention will now be described with reference to the drawings of the application in which:

FIG. 1 is a block diagram of an RDS/RBDS encoding system of the prior art.

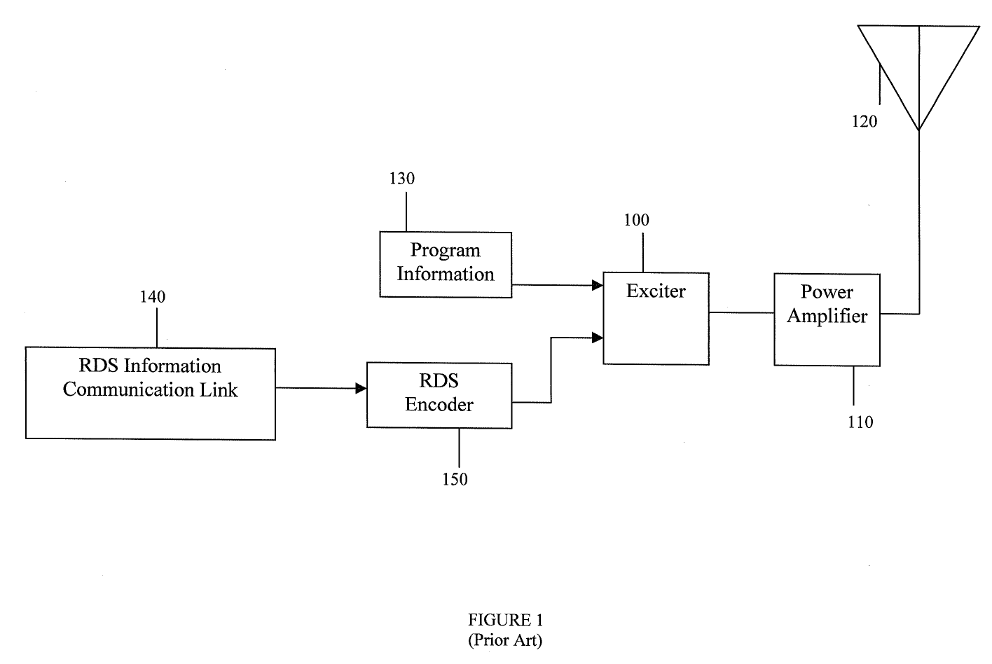

FIG. 2 illustrates spectrum utilization of an FM transmitter using RDS/RBDS.

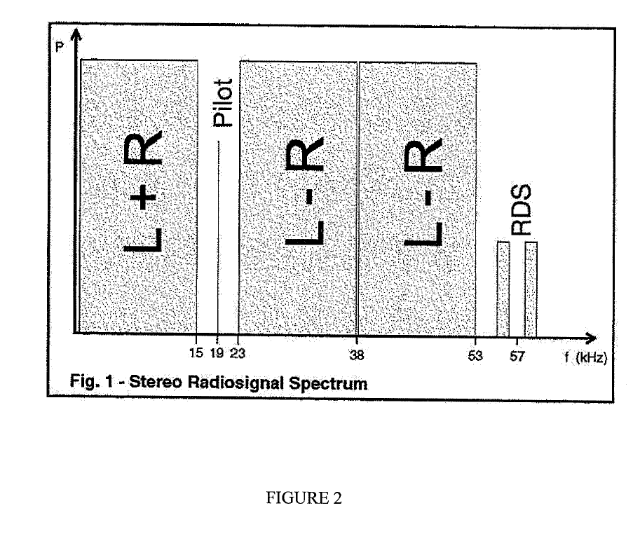

FIG. 3 is a block diagram of a prior art early warning system using RDS.

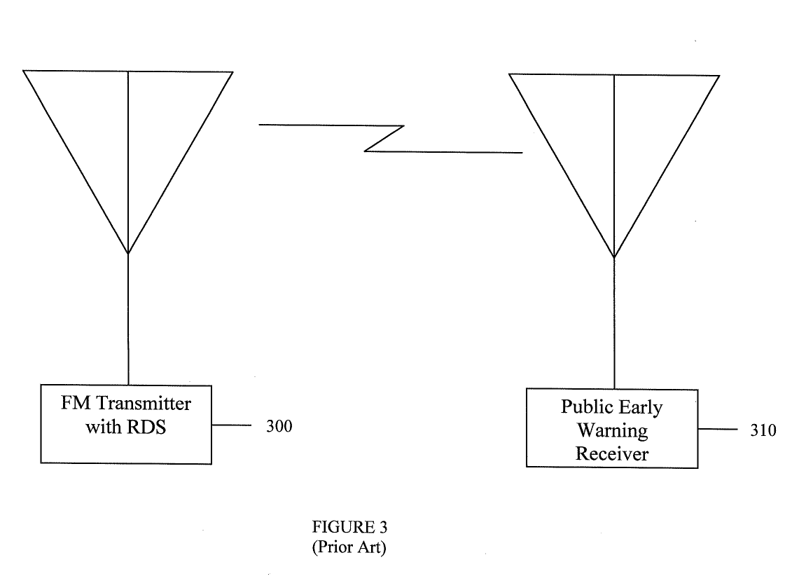

FIG. 4 is a block diagram of an improved RDS/RBDS system in accordance with one aspect of the invention.

FIG. 5 is a block diagram of an optional equipment configuration for a network operating center in accordance with one aspect of the invention.

FIG. 6 is a high level logical description of the operation of the RDS/RBDS system of FIG. 4.

FIG. 7 is a block diagram of functionality accessible from the welcome screen of a server application.

FIG. 8A is a screen shot of a log in screen of a main server application.

FIG. 8B is a screen shot of a welcome screen displayed once a user logs on.

FIG. 8C is a screen shot showing functionality associated with the network administration tab of various screens.

FIG. 8D is a screen shot of a screen used for destination group management.

FIG. 8E is a screen shot of a screen used for user group management.

FIG. 8F is a screen shot of a screen used to add an external destination to a user configuration.

FIG. 8G is a screen shot of functionality associated with the user administration tab.

FIG. 8H is a screen shot of a screen used to add a user to the system.

FIG. 8I is a screen shot of functionality associated with generating a custom message.

FIG. 8J is a screen shot of showing a confirmation check before sending a custom message.

FIG. 8K is a screen shot showing functionality associated with sending a prepared message.

FIG. 8L is a screen shot showing selecting of a prepared message to send.

FIG. 8M is a screen shot showing functionality associated with the program radio tab of various screens.

FIG. 8N is a screen shot showing functionality associated with remote update of a radio device.

FIG. 8O is a screen shot associated with functionality associated with the alerters rule tab of various screens.

FIG. 8P is a screen shot showing an exemplary cap file format.

FIG. 8Q is a screen shot associated with set up of an alerter rule.

FIG. 9 is the depiction of a radio receiver in accordance with one aspect of the invention (shown in FM mode).

FIG. 10 is a depiction of a similar radio receiver shown in the alert mode.

FIG. 11 shows alternative connections which can be utilized for direct access to an RDS encoder.

FIG. 12 shows a screen shot of user interface software, that the user can activate when desiring to directly connect to the RDS encoder.

### DETAILED DESCRIPTION OF THE INVENTION

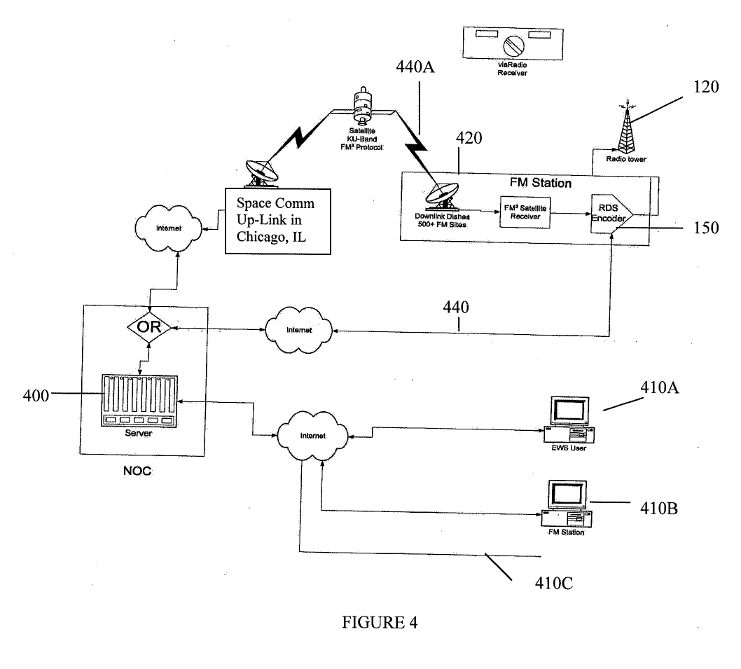

FIG. 4 is a block diagram of an improved RDS system in accordance with one aspect of the invention. The operation of the system is centered around a server 400 which has the functionality described more in detail hereinafter. The server is part of a network operating center (NOC). When the server determines that a message needs to be transmitted to a destination group, it routes that message to an RDS encoder via one of two communication mechanisms.

In a first option, the server packages the alert to be broadcast for transmission over the Internet via link 440 to an RDS encoder which can receive, extract information to be sent and send the information over the RDS subcarrier. Such a decoder is shown at item 150 in this figure. A second way to get information to the RDS encoder 150 utilizes a satellite link. Specifically, the alert can be sent via the Internet to an uplink, such as a Space corn uplink facility in Chicago Illinois for transmission over a Ku Band satellite and down to a downlink dish and receiver at the FM station via link 440A. The difference between the two paths has to do with the protocol or the packaging of the alert to accommodate the protocol needs of the Internet equipped RDS encoder or the satellite equipped RDS encoders. The packaging would need to accommodate the Space corn uplink protocol needs at the Chicago facility.

Access to the server is preferably over the Internet. A variety of users, only two of which are shown in the drawing can utilize this access as described more hereinafter. An emergency warning service user 410 can log on to the server 400. With an appropriate set of permissions, the user 410A can generate an alert, either customized or pre programmed, for transmission over the RDS encoder 150. Similarly, user 410B can be utilized at the FM station itself to initiate alerts over the RDS encoder 150 in the same manner. The Internet also provides access to a number of other data providers labeled generally as 410C which can be accessed by the server in a query mode. These various data providers can be scanned for information that might be relevant to the user community served by the destination groups defined by the server 400. The users can also include the owner of an individual radio to program the radios capabilities, such as when the user moves and needs to change the location information associated with the alerting radio. A typical alerting radio is shown in item 430 of FIG. 4. Preferably, this is an alert radio supplied by 2wcom model EWR02 which has been modified as discussed more hereinafter. 2wcom is located in Flensburg Germany.

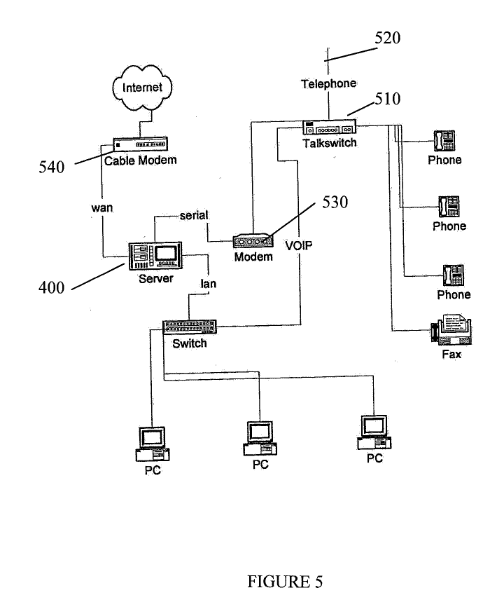

FIG. 5 is a block diagram of an optional equipment configuration for use at a network operating center (NOC) in accordance with one aspect of the invention. As shown here, the server 400 is also provided with information from a data switch 500 which passes data from the various PC's associated with that switch over a LAN. Additionally, a Talk switch 510 services telephones and fax machines within the operational center and provides access to external telephone lines 520 as well as Voice Over IP (VOIP) access to the data switch 500. Additionally, the Talk switch 510 can provide serial data over a modem 530 to the server for transmission over a wide area network to the Internet via, for example, a cable modem 540.

The configuration shown in FIG. 5 is optional but does facilitate the operation of a backup network operating system which is remote from the network operating center 400 shown in FIG. 4. This configuration would permit easy update of a hot or a warm stand-by server remotely over the Internet.

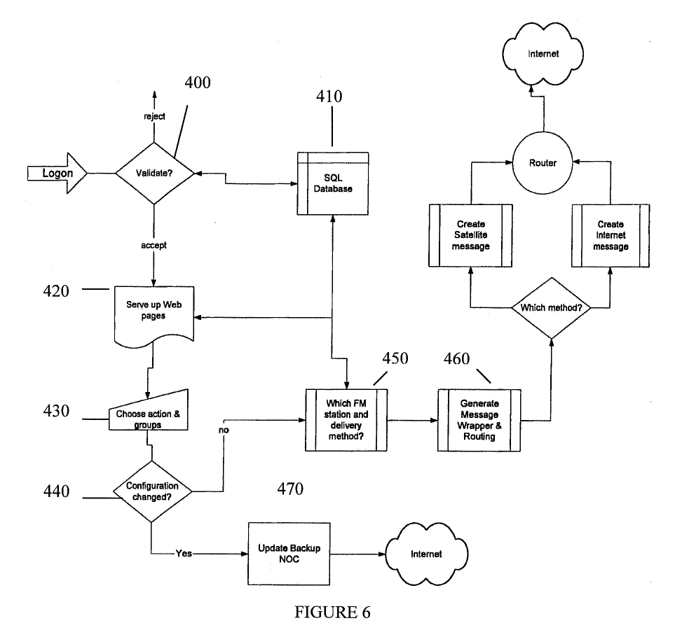

FIG. 6 is a high-level logical description of the operation of the RDS system of FIG. 4. When a user logs on, his log on ID and password are checked against an SQL database 410. If his log in and password ID are accepted, the SQL database 410 will provide access to the appropriate set of web pages that are consistent with the security level permissions associated with the user logging in. The user then uses the web pages, described more hereinafter, to select the action for groups and possibly to change configuration. Associated with the user are one or more FM stations and delivery methods for sending the messages generated or retrieved by the user logging in. Once the station and delivery method are determined at step 450, the message to be sent is generated (460) in the appropriate wrapper for routing either via Internet or satellite as discussed in conjunction with FIG. 4.

If the log on user has changed the configuration, 440, the new configuration will be transmitted to the backup network operating center 470 via the Internet.

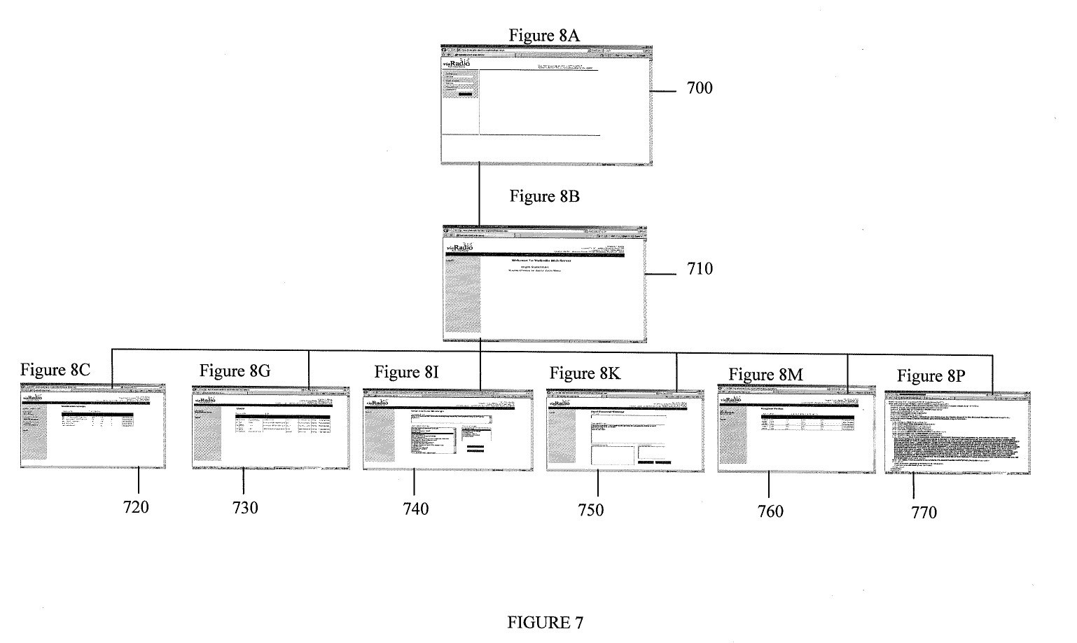

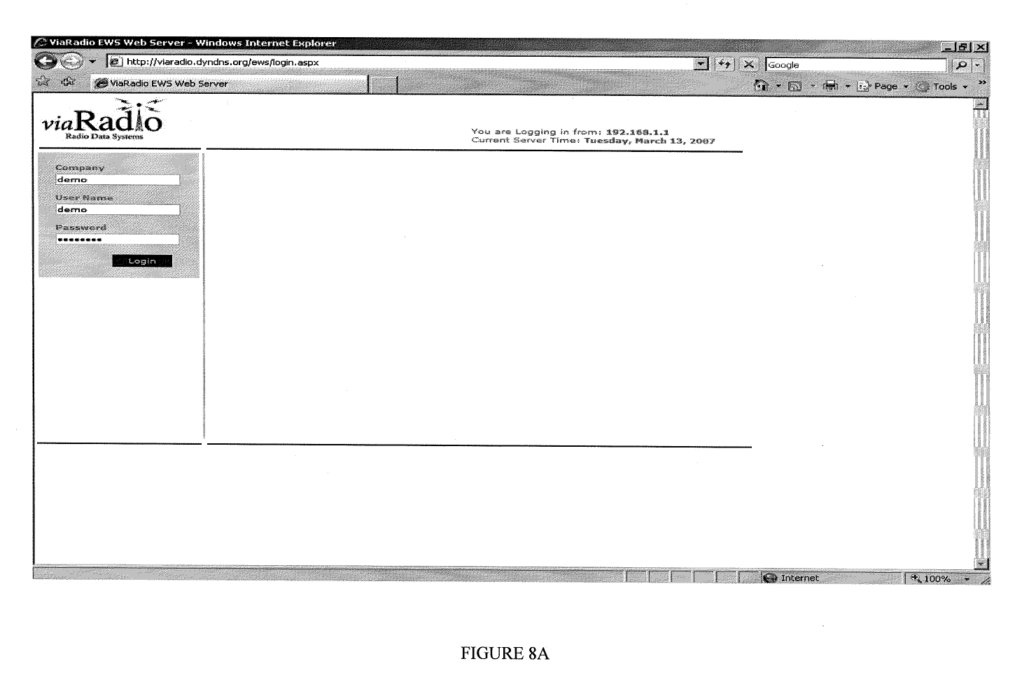

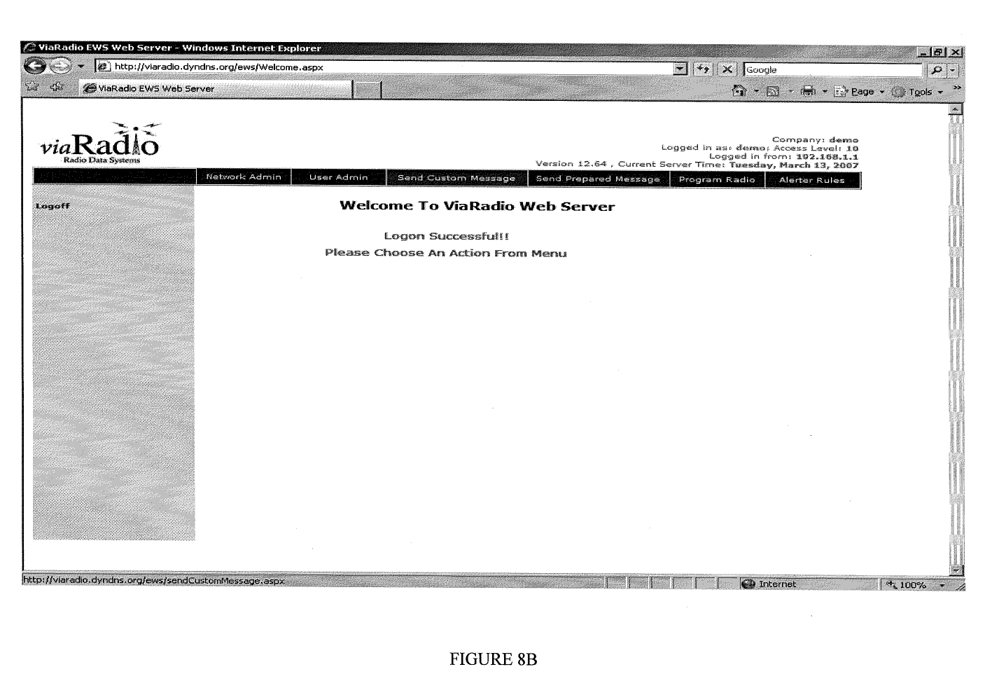

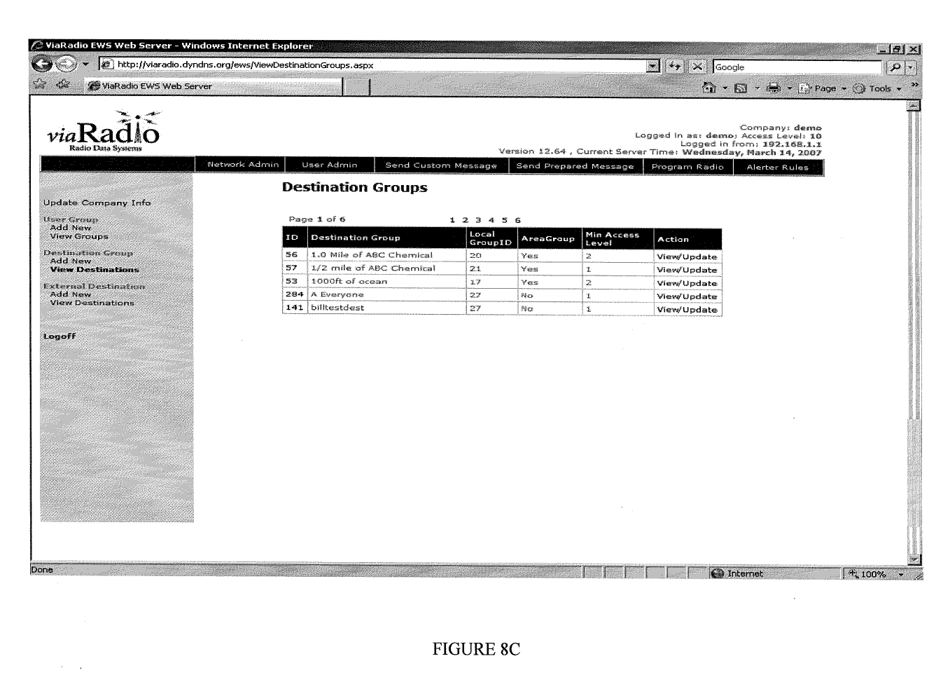

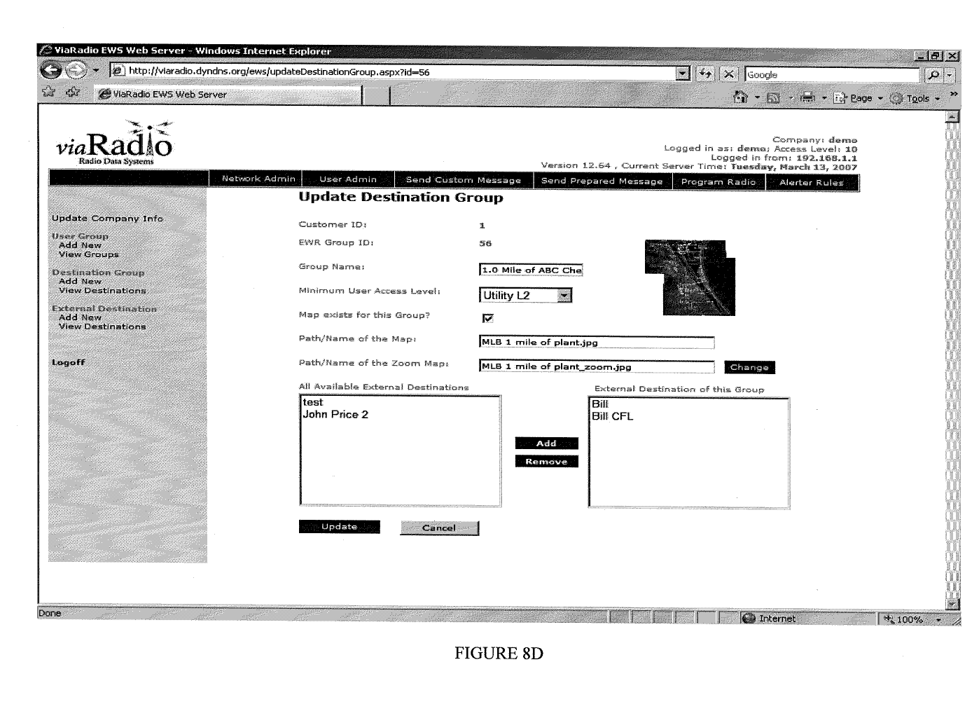

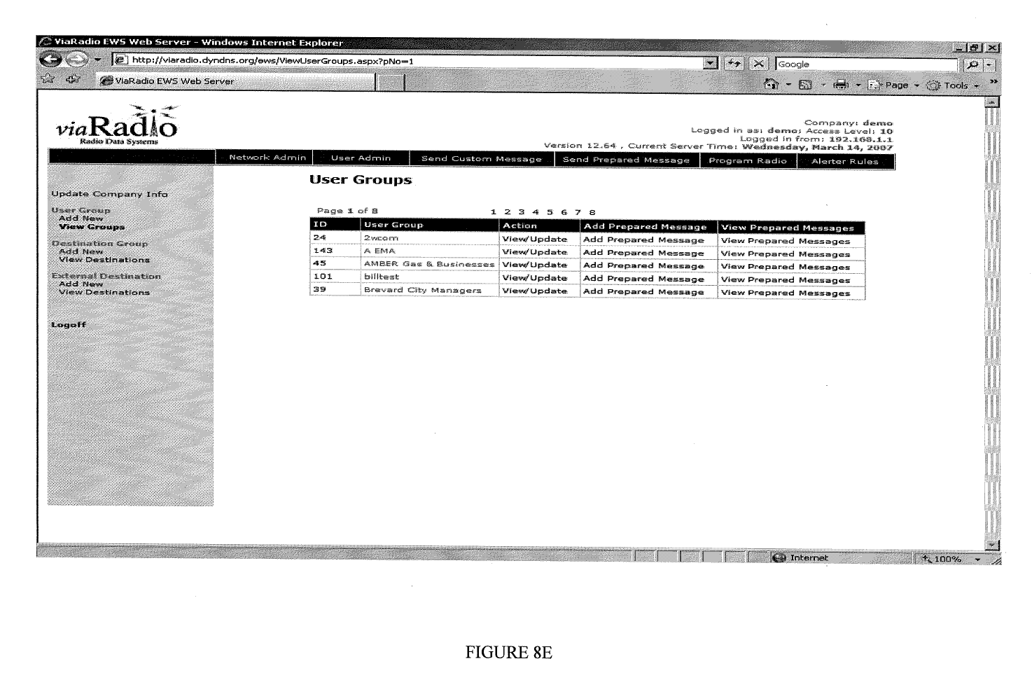

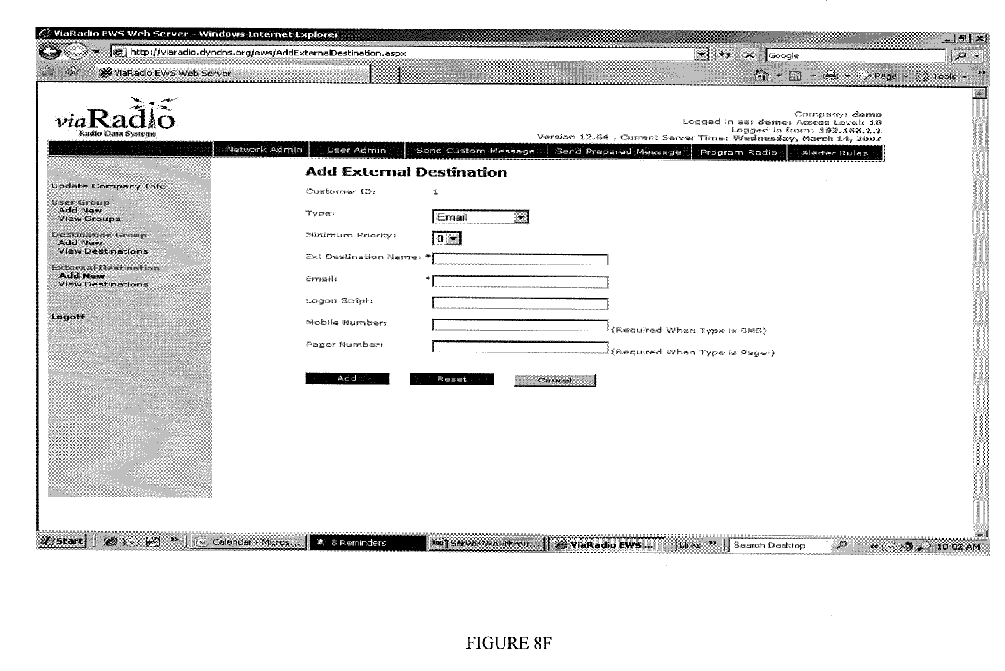

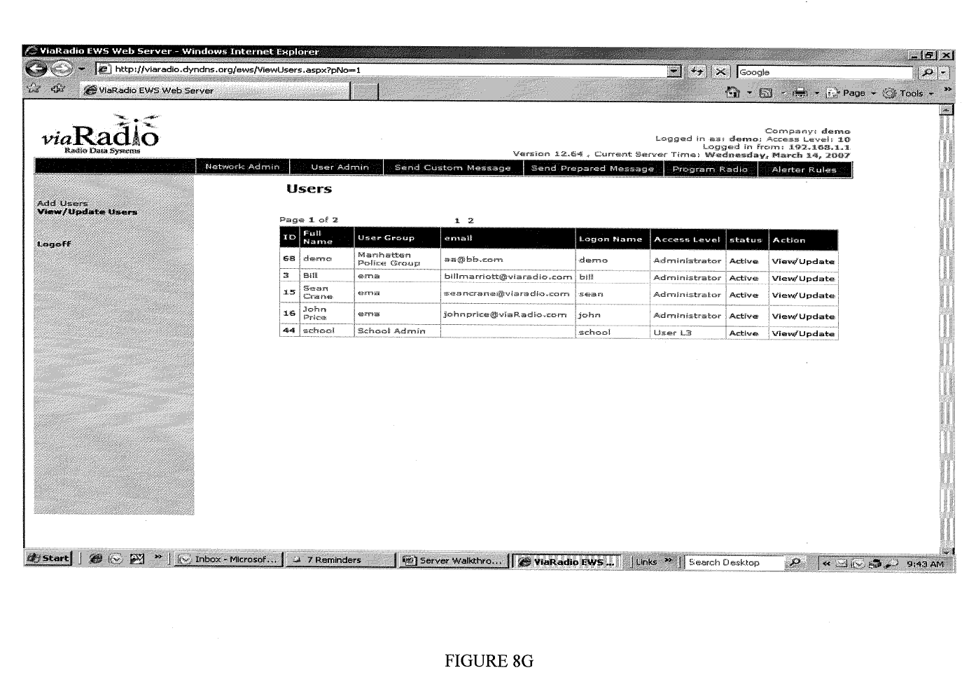

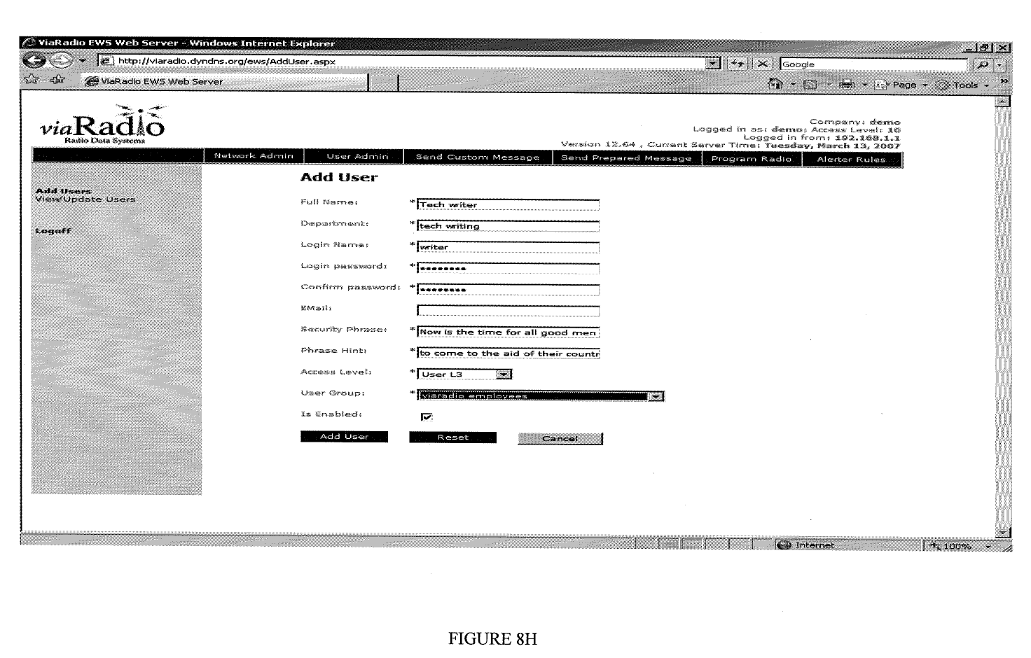

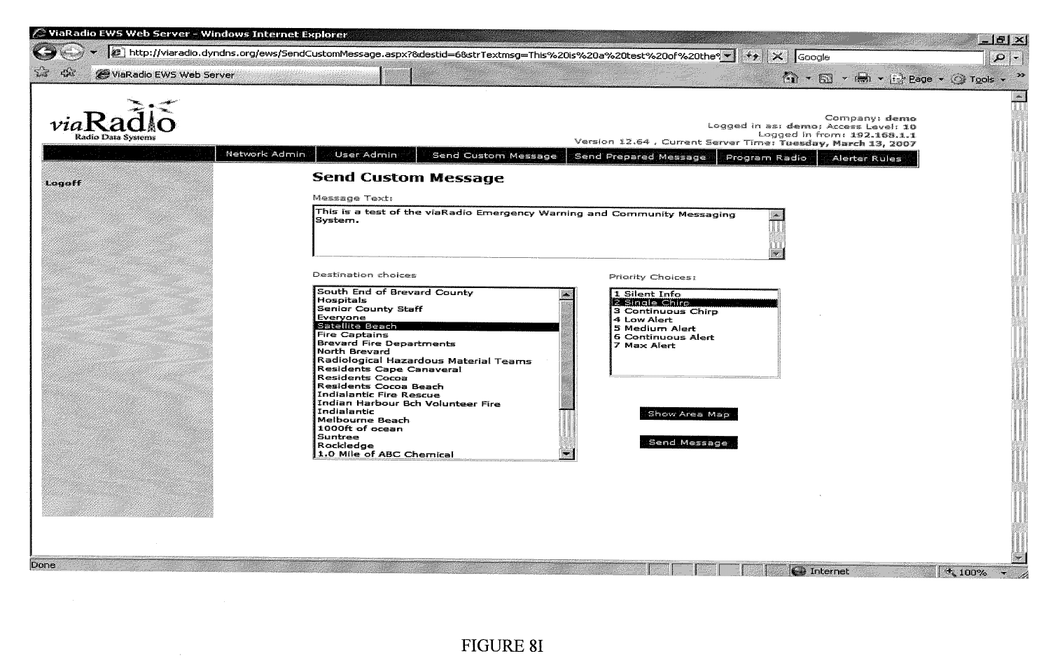

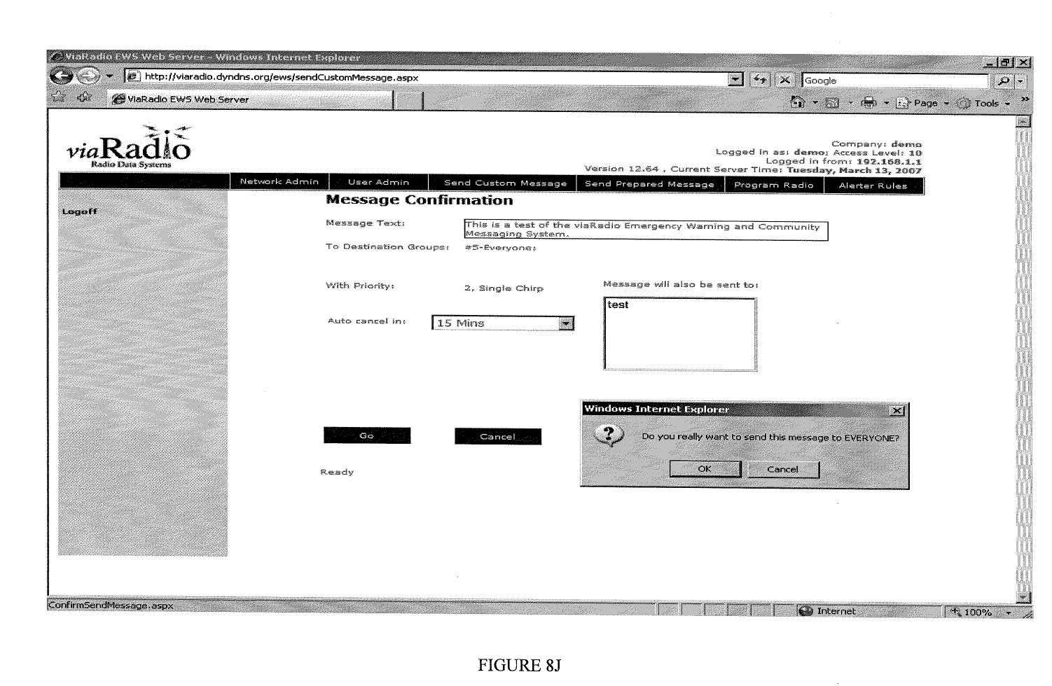

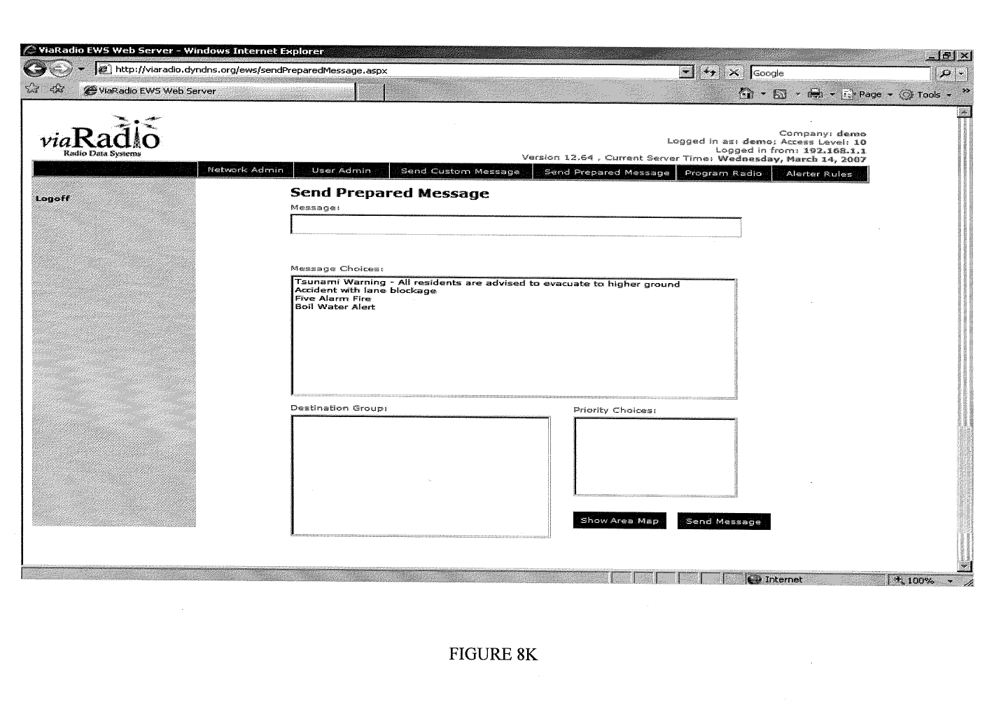

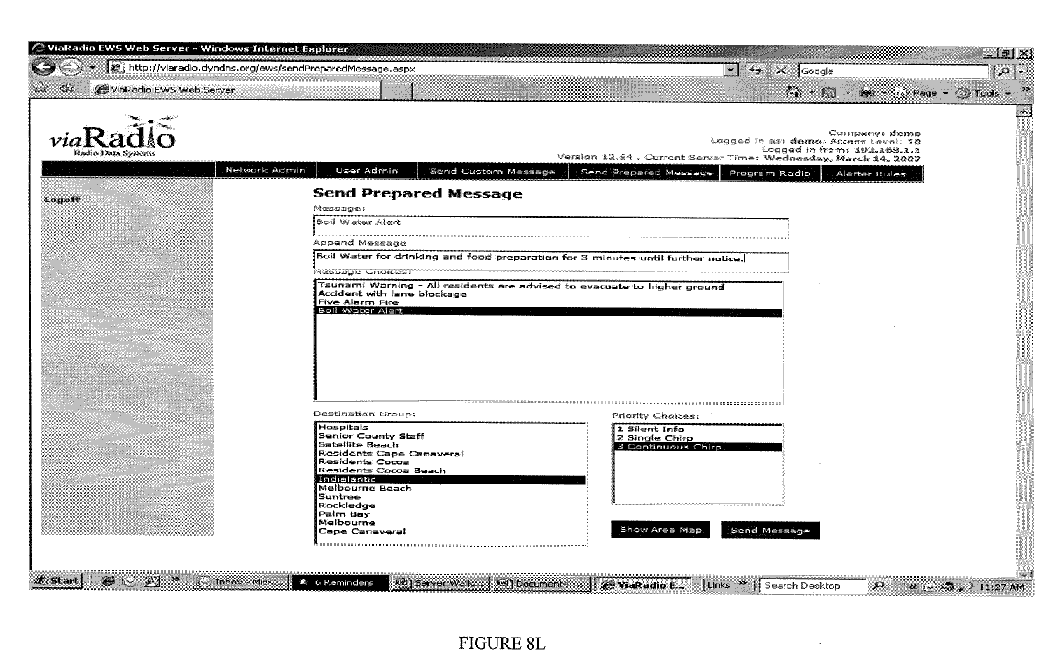

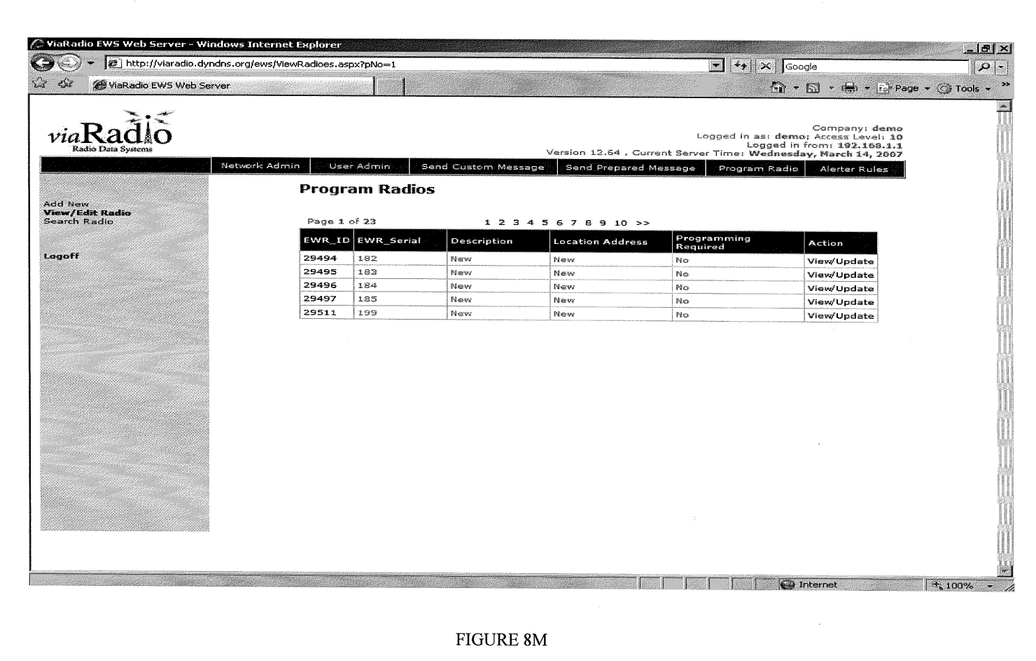

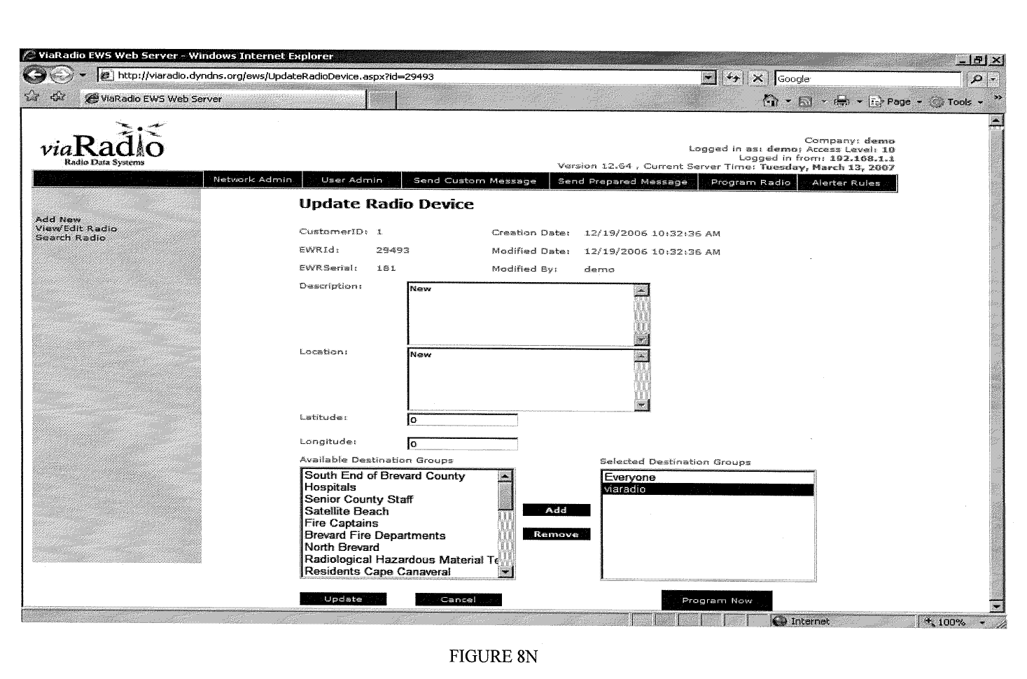

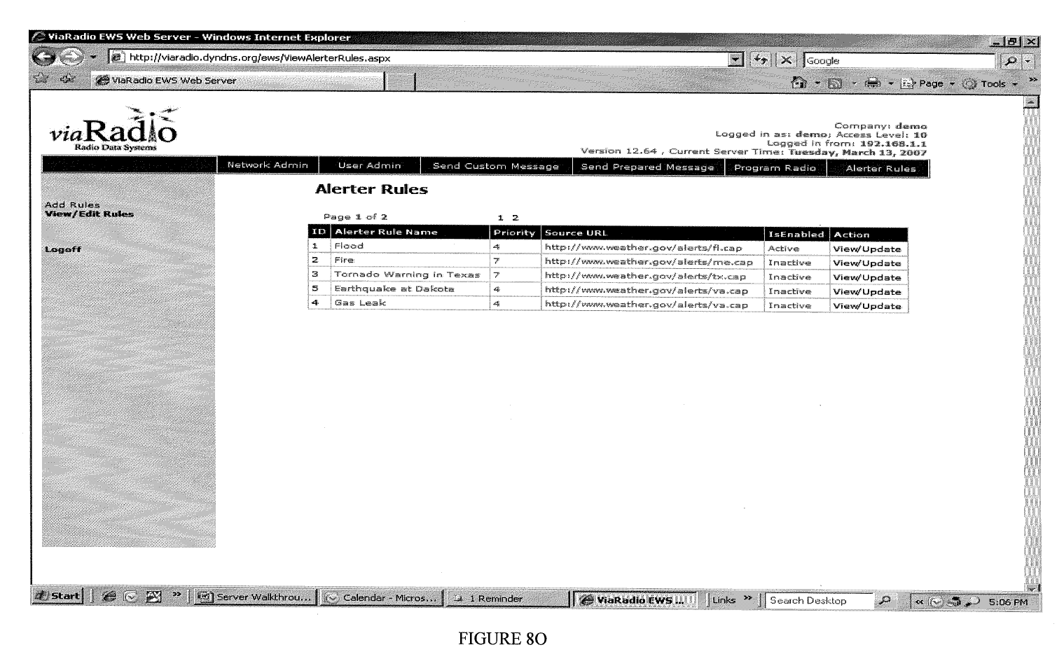

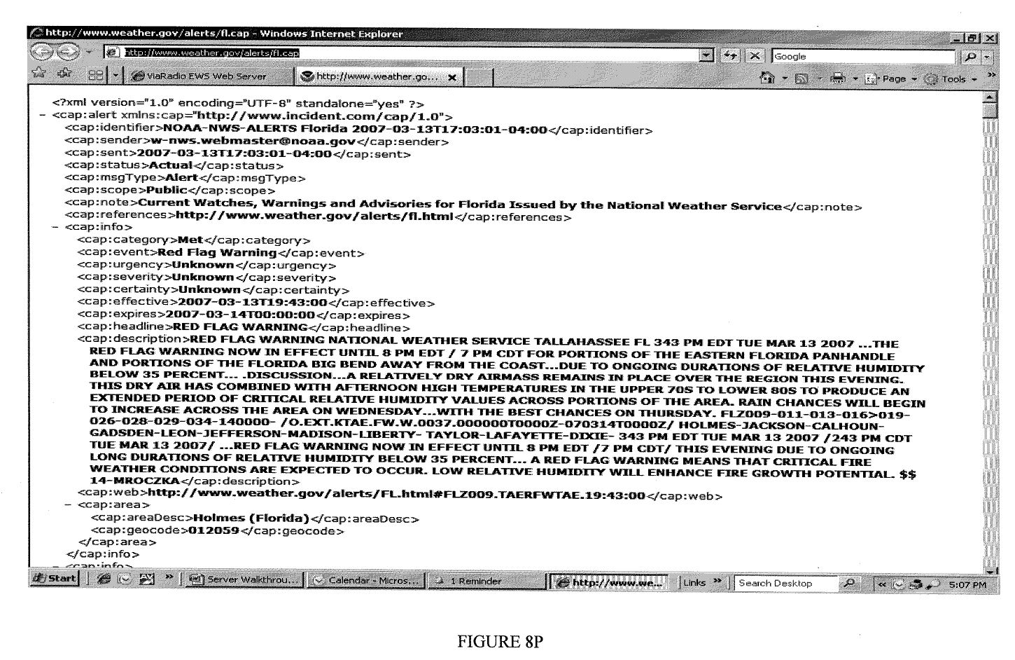

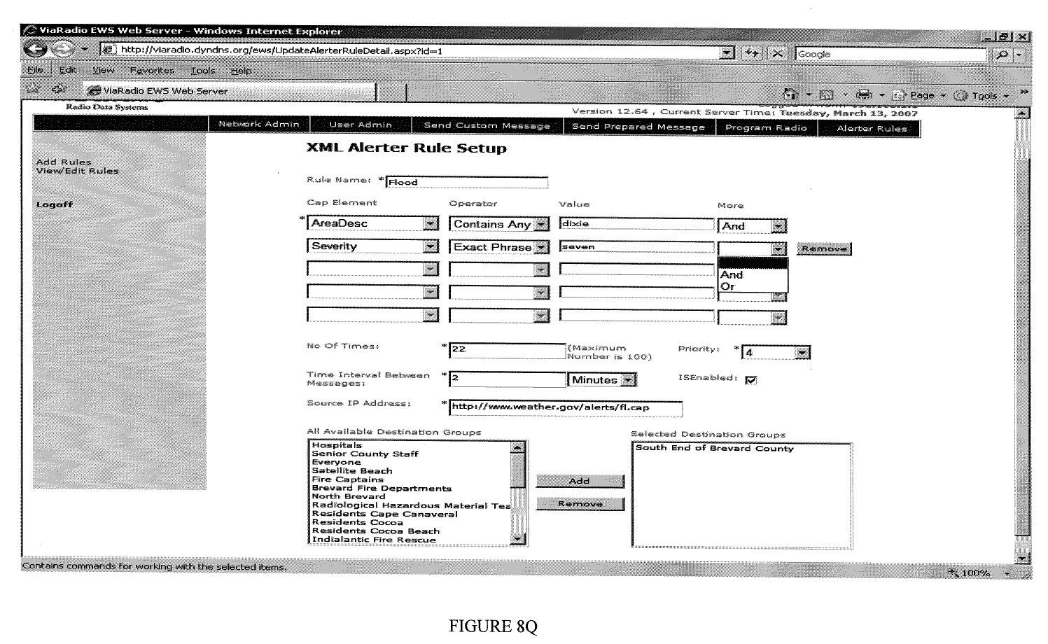

FIG. 7 is a block diagram of functionality accessible from the welcome screen provided to a user in response to successful log on. The log on screen 700 is shown more in detail in conjunction with FIG. 8A hereinafter. The welcome screen 710 is shown more in detail in conjunction with FIG. 8B hereinafter. Across the top of the welcome screen and across numerous other screens used during the use of the system, a variety of tabs are positioned which allow selected functionality to be invoked. The screens associated with network administration tab 720 is shown more in detail beginning with FIG. 8C. The functionality associated with user administration 730 is shown more in detail in conjunction with FIG. 8G. The functionality associated with send custom message function 740 is shown more in FIG. 8I. The functionality associated with the send prepared message tab 750 is shown more in detail in FIG. 8K. The functionality associated with the program radio tab 760 is shown more in detail in conjunction with FIG. 8M. The functionality associated with alerter rules 770 are shown more in conjunction with FIG. 8P.

FIG. 8A is a screen shot of a log in screen utilized in accordance with the invention. Note that data inputs are displayed and occur along the left margin of the main screen area. A user types in a company name, a user name and a password and pushes the log in button. As noted above, security permissions are checked and if the user is an authorized user, he is permitted to log on to the system.

FIG. 8B is a screen shot of a welcome screen that a user receives when log on is successful. Again, note that along the left margin are certain commands and options available to a user at this screen level. Note also across the top of the screen, the six tabs discussed in conjunction with FIG. 7 are positioned, namely the tabs associated with network administration, user administration, send custom message, send prepared message, program radio and alerter rules. Each of those tabs permits access to certain functionality described more hereinafter.

FIG. 8C is a screen shot of the functionality associated with the network administration tab of the welcome screen. Displayed on this screen as indicated by the bolded menu selection in the left hand column of the display are the destination groups. The functionality associated with the network administration screen is listed in the left hand column in the shaded area. This includes updating company information, managing user groups (including add and view groups) managing destination groups including adding and viewing destination groups and external destinations including adding and viewing external destinations. Log off is also an option.

FIG. 8D is a screen shot of an update destination group functionality selected from the network administration tab. Each customer has a customer ID which is a numerical entity. The user associated with the customer ID has an early warning radio group ID, in this case 56, and an associated group name, which in this case, although abbreviated, indicates that the user is located within 1.0 mile of the ABC chemical plant. The next entry indicates that the user has a certain set of access permissions, identified in this case as utility L2. Certain groups of users may be associated with a particular map. If such a map exists, a check is placed in the map exist block. The name of the image of the map and, if desired, a second image of the map which is zoomed with respect to the first. All available external destinations that are not external destinations associated with this group are displayed in the left hand box. Those, which are associated with as user and this group are shown in the external destination of this group box on the right. These may be added or removed as indicated. And if any changes have been made, the destination group will be updated using the update button in the lower left hand column. Obviously, if the changes are not desired, the user may cancel the operation.

FIG. 8E is a screen shot showing the user group management functionality of the network administration tab. In this case, the user groups are viewed and each can be selected and edited, appropriately.

FIG. 8F is a screen shot of a screen used to add external destination. In some cases, users desire not only to be alerted through their early warning radio but to also receive other forms of alert. These can include an email alert or an alert via SMS or other messaging technique to their mobile telephone number. When a pager is available they might desire to be alerted by pager. That is function of an external destination when a user is a target of an alert message by virtue of its membership in a destination group, it may be that he wishes to be notified via this other media. In this case, the add external destination permits the user to be alerted in multiple ways.

FIG. 8G is a screen shot of functionality associated with the user administration tab on the server screens. From the screens shown in FIG. 8G, one may update the information associated with a particular user.

FIG. 8H shows a screen shot of a screen used to add a user. It is very similar to the screen utilized to update a user information. When adding a user, the user's name is added, user's department, user's log in name and password and appropriate security phrases and security phrase hints. The user's permission levels are set and the user's membership in a user group is specified using a drop down menu of user groups. A check box will show if the user's early warning radio is enabled.

FIG. 8I is a screen shot of functionality associated with the sending a custom message tab on the screens. This screen allows a user to compose a custom message in the message text box shown on the screen. The person composing the custom message can select the destinations that need to receive the message and the priority choices associated with the messages to be sent to those destination choices. There is a screen option that permits an area map to be viewed that is associated with the destination group. When the composition of the message is completed, the send message button is pressed.

FIG. 8J shows the use of a confirmation check prior to sending the message. In this case, the pop up box will ask if the user really wants to send that message to everyone. Note that the message confirmation includes an automatic cancellation field, which permits the user to specify that the message will be automatically cancelled in a certain amount of time. It is possible to manually cancel the message or to have the message sent with no automatic cancellation so that manual cancellation must be initiated in order to end the sending of the message.

FIG. 8K is a screen shot of functionality associated with the sending prepared message tab of the screens. A number prepared message choices are set forth in the message choices block associated with the user.

FIG. 8L shows an screen shot of a screen invoked when a message is selected from the FIG. 8K message choices box. In FIG. 8L, when a message choice is selected, in this case the boil water alert, the name of the message is placed in the top box and the text of the message that goes with that is placed in the append message box immediately underneath the message name. The destination groups to which the messages are to be sent are specified and the priority of choices associated with the prepared message are set forth in the priority choices box. A user with high level authority or permissions has a greater variety of choices of priorities in which messages can be sent out. He also has a greater variety of destination groups available to receive the message. A low level of permission as shown here does not include the full set of priority choices.

FIG. 8M is a screen shot of functionality associated with the programming radio tab of the screens. Each early warning radio has associated with it an ID and a serial number. When a radio is added to the system, the screen shown in FIG. 8N which is associated with the radio, by EWRId new serial number is provided to the user for entering in additional information. Data for an existing radio which has been entered as part of this system produces a similar screen which can be edited and updated as appropriate. Information about the radio is included in the description including its location by address and its location by latitude and longitude, if desired. The destination groups available throughout the system are shown and those that are appropriate for this radio device are selected and added to the selected destination groups box on the right at the bottom of the screen. When the programming information has been entered on the screen of FIG. 8N, the program now button is pushed if it is a new radio being added to the system or an update button is pushed if one is changing the information associated with a radio that is already part of the system.

FIG. 8O is a screen shot of functionality associated with the alerter rules tab of the screens. A number of services provide information on alert situations. The server automatically and periodically scans specified common alerting protocol (CAP) files from the Internet as specified by the customer and then searches the files for matching key word and event codes. If a match is found then a message to a specific destination group is generated. One source of CAP files is the National Weather Service. A listing of the CAP files associated with specific alerts is shown in FIG. 8O. If there was a danger of flooding, and more specifically a danger of flooding in Florida, the server would go to the address the source URL address shown under item number 1 of the alerter rules and scan that file for locations that were relevant to its service area.

FIG. 8P is a screen shot exemplifying a CAP file format such as might be found on the web site of www.weather.gov. This alert file has specified by the entry “<CAP: area Desc>Holmes(Florida)</CAP:areaDesc>” which is an XML designation of the area impacted by the alert. If the user had entered Holmes Florida as a destination of interest in the rules setup, the text of this information would be available for sending an alert to users in the effected area.

FIG. 8Q is a screen shot of a set up for an alerter rule. The various XML elements are specified various operators are specified and the value is specified for the CAP element. In this case, any alert affecting the value dixie in the area description element and has a severity exactly 7 would be reported and sent as an alert. The source IP address of the CAP file is given and the destinations within the system which can be utilized to specify which radios receive the alert, can be selected from the left box and placed in the right box for activation. Thus, the XML alerter rule set up specifies which CAP files will be periodically accessed and will provide alerts to the appropriate communities that would be impacted by the alerts.

A possible operational scenario of the use of this server will now be described.

Customer runs a chemical plant and the overnight operator on duty sees a “leak detected” alarm on his console. Operator logs onto our server and sends a medium priority message to that effect to group #4—which is comprised of duty shacks around the plant, and Maintenance supervisor at his office and bedroom at home.

8 minutes later, he gets a radio call from an on-duty maintenance person validating that vapor is leaking and that it is Chlorine, toxic and uncontained. He then follows his emergency procedures which include sending message #4 to group #2 which is a high priority message with text “uncontained Chlorine leak”. This goes to the homes of senior management and wakes them up.

3 minutes later, the plant manager calls in and is briefed on the size of the leak and the amount of chlorine released. He directs the operator to send a warning message to first responders. The operator types the following “Chlorine gas release at AcmeChem—possibly drifting SE Toxic gas protocol #2”. He sends it to group #7 which includes nearby fire, police and hospital locations.

5 minutes later reports start to come in from police that 911 calls are coming in from the Sunny Isles subdivision about the smell. Weather and winds are inspected and a plume path estimated.

The plant operator then consults the map of EWS radio grouping and sends an urgent priority alarm warning residents about the leak and asking them to immediately close all windows and cover up children with wet towels. This goes to groups #12, #13 & #15 which are three subdivisions in the path if the cloud—about 500 homes. The first responders radios are also members of these groups so they get the same message too. Time to alert these 500 households and wake everyone up is about 30 seconds.

1 hour later these same groups get a medium priority “all clear” alert.

The rapid waking up of the endangered houses allowed them to take precautions in time and avoid injuries, saving lives, and saving the plant millions in lawsuits.

### The Radio

The radio shown as item 480 of FIG. 4 is preferably a 2wcom dual tuner radio model EWR02, modified in ways that we will now describe.

### Primary Function

The warning receiver shall (1) be a Warning Receiver that monitors transmitters that broadcast EWS Warnings (Warning Announcement and Alarm Code in RDS). If there are several transmitters in the area capable of broadcasting a Warning, the receiver shall (2) be capable of choosing the best signal.

For identification of transmitters capable of sending a Warning the receiver shall (3) evaluate the ODA Application Identification Code in Group type 3A, in the RDS-system.

It shall (4) also evaluate transmitted ODA groups and present additional information to the user.

It shall (5) also be possible to use the receiver as a standard domestic FM-receiver with high sensitivity for reception of the EWS station, other presets, manually tuned stations and arbitrary Private Local Radio (PLR)-stations while still monitoring the EWS station. The receiver shall (6) be capable of providing all standard RDS functions.

### Receiver Operating Modes

There are several different modes. The “Normal mode” which is standard operating mode for the receiver, the “Self monitoring mode” which is for error detection and the “Warning modes” which are divided into different levels of importance.

### Normal Mode

Normal mode shall (7) be the standard operating mode for the device. In this mode it shall (8) be able to receive a Warning. If no Warning is active, it shall (9) also be possible to listen to ordinary radio broadcasts on any station selected by the user. When a Warning is detected it shall (10) be possible to automatically switch from any ordinary radio station and switch to a Warning transmitter. Additionally it shall (11) be possible to display broadcasted information messages and to update the configuration of the receiver on air.

### Warning Modes 3.2.2.1 PTY31 Warning Mode

When there is a need to warn the public the Warning Announcement and the Alarm Code (PTY 31) are broadcasted. The receiver shall (12) then automatically switch to “PTY31 Warning” mode. In this mode the receiver shall (13) switch to the second tuner, emit an audible signal, automatically resound the Warning Announcement at pre-programmed level and indicate by a visible signal (flashing LED) that is different from Normal mode. Moreover the words Important Message or a received Radiotext shall (14) be displayed in the LCD. The receiver shall (15) automatically return to Normal mode when PTY 31 is no longer broadcast, but the indication shall (16) remain until manually reset.

For Testing purposes if a PTY 30 test alert is active the radio shall (17) behave like in PTY 31 mode.

### ODA Warning & Messaging Mode

In this mode, messages are addressed to specific groups of radios which respond in various manners depending on the priority code of the message. If a radio receives a message to an address that matches one of the destination addresses programmed in the radio, then it shall (18) automatically enter “ODA Warning Mode” Depending on the priority code and the actions configured for that priority code, the radio may tune to a warning station, immediately display the text message, beep at various intervals, adjust the volume to a specific value, activate the relay, enable serial output and blink the LED at various intervals.

There are eight priority levels and any message displayed shall be replaced by a new message having an equal or greater priority code.

### Self-Monitoring Mode

The receiver shall (22) have a built-in test program for automatic self-testing. When no Warning is active receiver shall (23) switch to self-monitoring mode when it automatically detects that something unusual has occurred. If any function is not normal the result shall (24) be presented on the LCD. The user shall (25) be informed of the receiver status and what actions will be taken by means of plain text or icon that appears on the LCD.

### Clock Radio Function

The receiver shall (36) be designed for use as a Clock Radio.

The receiver shall (37) be provided with a free running clock. The clock shall (38) be updated by the RDS/CT information of the warning station. The free running clock will be quartz crystal controlled and the time will be displayed.

### Detection

According to the Specification of the RDS system: CENELEC EN 50067: 1998.

The receiver shall (44) detect our system ODA beacon code in group 3A and Program Type ALARM (PTY 31).

In the “ODA Warning mode”, the receiver shall (45) additionally detect special warnings broadcast with ODA commands.

To evaluate ODA Warnings the receiver shall (46) detect the “WA” (Warning active) bit in group 3A as defined in the RBDS EAS specification.

### Advanced Warning Functionality

It shall (56) be possible to address receivers or groups of receivers, using warning priorities and multiple ways of signaling. An evaluation of more complex ODA commands shall (57) be done to convey the necessary data.

### Improvements

There shall (58) be mechanisms for:
Receiving ODA Messages with complex functionality
Addressing of 4096 customers
Addressing of 4096 groups
Addressing of selected receivers
Evaluation of 8 different Warning priorities
Evaluation of different Datatypes
Text Commands (with embedded control characters)
Config Commands
Serial output—used for logging or external signaling
Multiple audio tones and levels
Scrolling of the messages in the display and a Display with Multiple Fontsizes
Configurable Display menus to display in different languages
Different clock alarms for the 7 days of the week (preset, time and tone)

### Customer ID

The receiver shall (60) respond to messages sent over stations using a particular Customer ID.

### Group Number(s)

The receiver shall (61) be able to be assigned to address groups. Some receivers will belong to a single group but some receivers may need to belong to multiple groups. Due to this group assignment, it will be possible for the customer to broadcast messages to predefined groups of receivers.

Every receiver shall (62) be able to be member of at least 10 address groups and a global group i.e. all radios or “Everyone”.

It should (3) also be possible to address an individual radio by using its serial number.

### Data Types

There shall (63) be different Data Types of messages. These Data Types are used to determine if a broadcast command is a text EWS message, a EWS config command, sw image or some other data type. Addressing is differentiated between group Addressing and Serial Number Addressing. If Serial Addressing is used the Message shall (64) only be acted upon by radios with that serial number (typically one). If standard group addressing is used, all radios shall (65) act on the message if the customerId and one of its groups equals to the customerId and the group address of the message.

A data type of “Command” means that the message is radio configuration data to be stored in the radio

| End of message flag | Will be sent to stop a Message |
|---|---|
| EWS Message | Indicates a text message |
| EWS Config command | Indicates a EWS Config message |
| EWS Program download | Indicates a EWS program message |
| EWS Message | Indicates a text message |
| (Serial Addressing) | (Addressing via Serial Number) |
| EWS Config command | Indicates a EWS Config message |
| (Serial Addressing) | (Addressing via Serial Number) |
| EWS Program download | Indicates a EWS program message |
| (Serial Addressing) | (Addressing via Serial Number) |

### Priority—Levels:

There shall (66) be different levels of priority. These levels determine what actions the receiver takes when it receives a message.

| Priority | Usage examples |
|---|---|
| 7 | Emergency Alert - eg “evacuate your home immediately” |
| 6 | High Priority Alert - eg “Explosion at Acme Chemical” |
| 5 | Medium priority alert - eg “forest fire approaching” |
| 4 | Low priority alert - eg “Please call office” |
| 3 | Important information eg severe weather |
| 2 | Just information - eg weather |
| 1 | News |
| 0 | Weather |

### Priority Parameters.

The radio shall (67) be able to alert in various ways, allowing for gradually more annoying settings. For user convenience, the priority matrix shall (68) have one default set that is easy to restore.
Volume 0-90
Relay action On or Off
Serial Output On or Off
Red backlight On or Off
LetterSymbol On or Off (If “On′, message does not scroll automatically)
Tone type Various beeping rates and repetitions
LED action Various blinking rates
Audio active Audio announcement (Switch to EWR tuner audio)

### Fragment Number

The receiver shall (71) be able to link messages together using the Fragment number.
Fragment number “0” is always the first message
Only fragments with fragment number “0” generate alerts
Every fragment except the last one occupies 90 characters
Every message fragment shall (72) be added to the last one, when the message number is increased by one to the last message number and the fragment number is increased by one to the last fragment number.

### EWS Messages

The main function of the radio shall (73) be to display complex EWS Messages.

These messages should (74) contain plain text with optionally embedded control codes for other external devices.

Eg “Chlorine leak in your area, go inside and close all windows $#23#$”

The escape characters and the 23 inside them shall (75) not be displayed by the receiver but shall (76) be output via the serial port to the speech synthesizer that then for example speaks message 23 saying “Poison gas leak—stay inside” which is repeated until snooze bar is pressed.

The Maximum length of EWS Messages shall (77) be 90 character for a single message and 720 character for multiple linked messages.

### EWS Config Command

An additional function of the US versions shall (78) be to configure the receiver by broadcasting EWS Config Commands.

The configuration shall (79) be able to get configured by a EWS Config command over the air.

### Configuration Fields Stored in FLASH

A network ODA beacon
Language table for 3 languages (Lookup table for words displayed by radio for different languages. This will allow radio to be used in any language by changing the lookup table)

### Configuration Fields Stored in EEPROM

Unique Receiver Address: Table of address groups (Allow 10 entries containing group number and customer ID)
Current Priority Matrix
Local Time format (12 hr eg 2:30 pm or 24 br eg 14:30)
FM tuning (0=100 kHz & 50 us Preemphasis, 1=200 kHz odd & 75 us, 3=100 kHz & 75 us, 4=200 kHz odd & 50 us)
Date format 0-2, 0=mm/dd/yy, 1=dd/mm/yy, 2=yy/mm/dd

### ODA Protocol

### General

All ODA data shall (80) be broadcast using one single ODA channel.

The ODA protocol shall (81) be encrypted

The ODA protocol is designed with consideration of:
Redundancy to handle bad reception
Easy transmitting of data to RDS encoders
Limited data bandwidth of RDS
Offering multiple messages at once

### Group 3A

The ODA Group 3A is used for the detection of our EWR transmitter.
Application Identification code:
   An EWR receiver detects a EWR-station when it receives our ODA beacon in the “Application Identification code” in a transmitted 3A group.
Group Type:
   The “Group Type” specifies the actual ODA channel in which the EWR ODA Data is sent out.
A
   The A-“Alert Active” Flag indicates if an alert is active.
Encryption ID
   The Encryption ID indicates which encryption has to be used in the EWR receiver to decrypt the transmitted ODA data
Customer
   The Customer bits indicate which customer the message is for. The EWR-receiver will only accept the transmitting station as an EWR station if the customer defined in the receiver equals the transmitted customer bits.

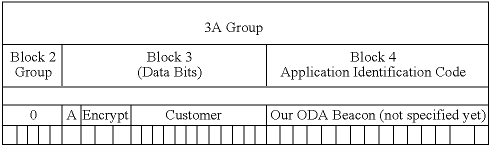

### Standard ODA Data Groups

The Standard ODA data group messages shall (82) handle the following parameters
Customer ID: 4096
Group number(s): 4096
Data type: 0-7
Message priority code: 0-7
Message: text, data or command. A data code can be embedded in the text message using an escape sequence

### ODA Messages

At the start of a message the data segment with address code “0” and Address code “1” have to be sent out
If a message isn't any longer it shall be finished by a data segment with address code “1” that contains a end flag in the “Type” slot (Type=O).
Every time a new message is transmitted the message number will be increased. If the message number would increase to 256 it switches back to 1.
If a new message is received by a radio with a message number that is already in use by an older message, the old one message gets erased and the new one will become active. The radio is able to notice that a message is new when in the received message the params (Customer ID, Group ID, Data Type, Priority, Length and Fragment) are different to the saved params of the old message.
Each character block gets its own address code so even if the error rate is high, the characters will maintain their position. If the “Serial no. addressing flag” is set in the data segment with address code “1” the customer and groups fields are merged together and represent the serial number of one receiver

### Text Message

Fields:Customer: Address of the customer
Group: Address of the group
Priority: Message priority code
Type: Data type
Length: Message Length
Text Character: Broadcast Characters of a Text-Message
Message No.: Number of the Message
Fragment: Fragment counter to link messages
CRC: Simple CRC-Code Comments:
If a message isn't actual any longer and shall be finished a data segment with address code “0” that (end flag) in the “Type” slot has to be received at least 10 times.
8 Bits are used for one character so 90 characters per message will be possible.

### Data Message

Fields:Customer: Address of the customer
Group: Address of the group
Priority: Message priority code
Type: Data type
Length: Message Length
Message No.: Number of the Message
Volume: Alert Volume
R: Relays—Activation Flag
Tone Type: Behavior of the “Alert—Tone” in case of an active alert
Led Type: Behavior of the red led in case of an active alert
S: Serial output activation in case of an active alert
B: Red Backlight activation in case of an active alert
L: Letter Symbol—display text immediately
A: Audio announcement (Switch to EWR Tuner)
CRC: Simple CRC-Code

With the 2wcom model EWR02 radio modified as indicated above, it can be used in conjunction with the architecture of FIG. 4 to achieve vastly improved functionality and flexibility over systems of the prior art. In addition, it allows the users of the system to directly manage the address space of the warning system in ways that are functional and flexible and meet the needs of the early warning community, in addition to meeting the needs of the community as a whole.

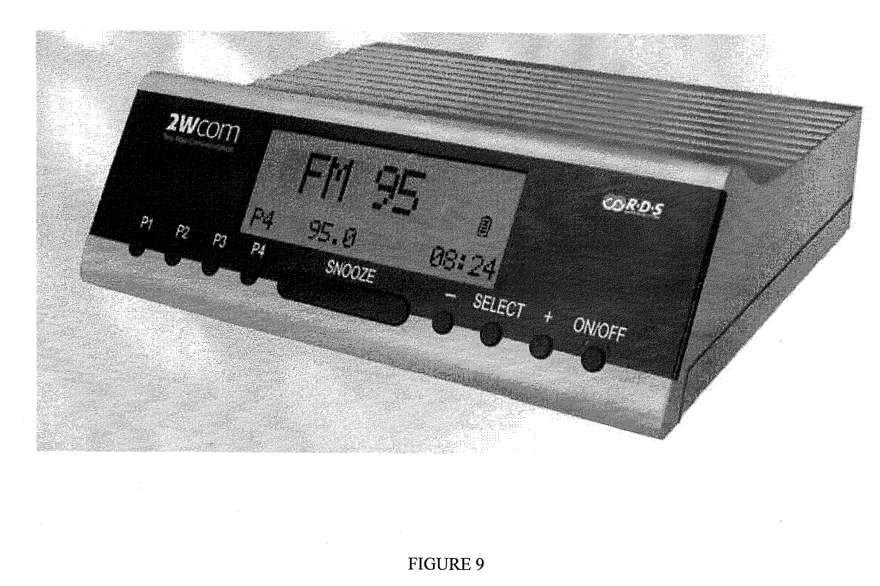

FIG. 9 is a depiction of a radio receiver in accordance with one aspect of the invention, shown in FM mode.

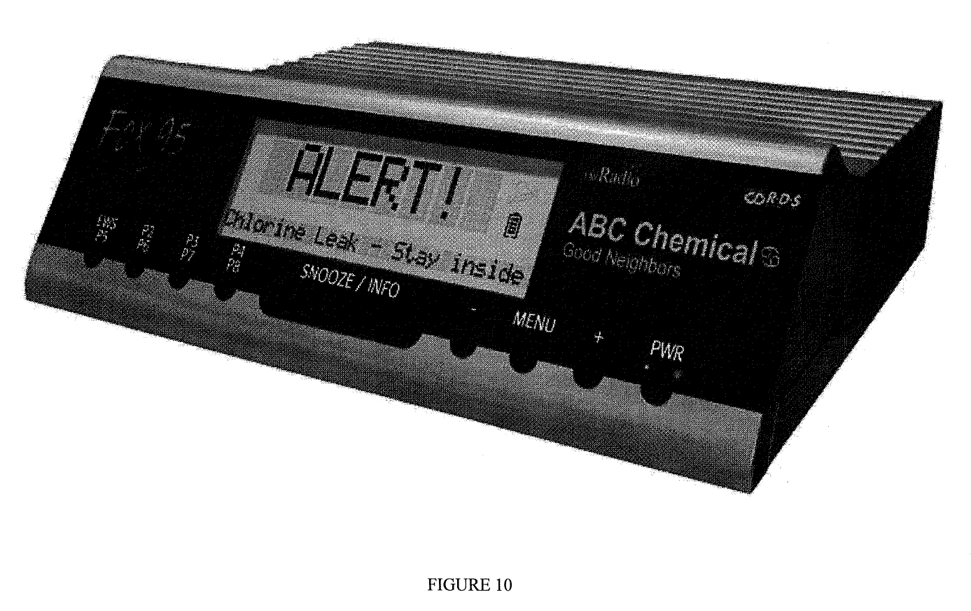

FIG. 10 is a depiction of a similar radio receiver shown in alert mode.

Since the primary connection method utilizes the server and the Internet for access to the server, users may want redundant or alternative communication paths. This problem has been solved by designing a piece of desk top software that resides on an end user machine that allows the user to connect directly to the RDS encoder at the FM transmitter station and send the message, without going through the server. That way in the event of loss of a server or of Internet connectivity, for example, cause by an earthquake, the user can use the stand alone software to connect directly to the RDS encoder.

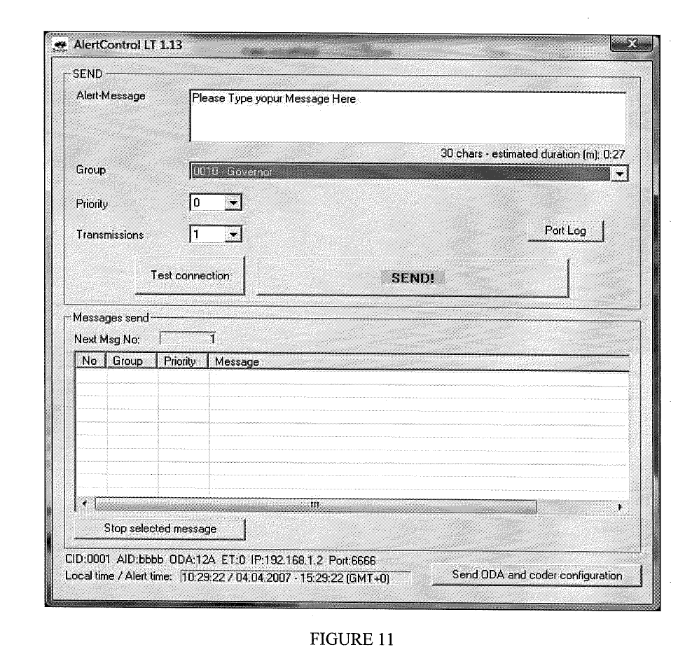

FIG. 11 shows alternative connections which can be utilized for direct access to the RDS encoder. As shown in FIG. 11, a wired or wireless modem can be utilized to create a direct serial or IP connection to the RDS encoder.

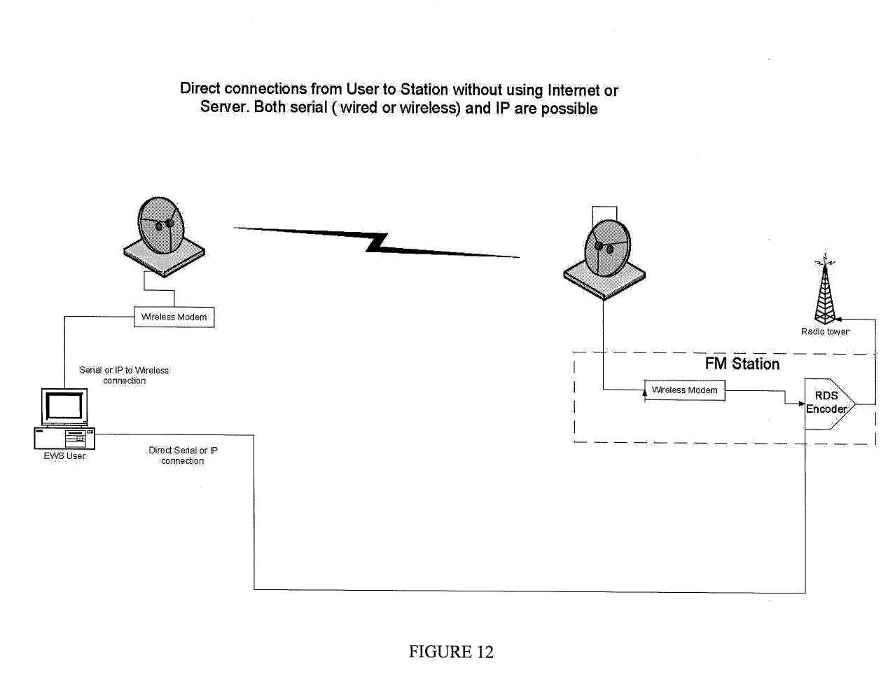

FIG. 12 shows a screen shot of user interface software, that the user can activate when desiring to directly connect to the RDS encoder. As shown in FIG. 12, the software has a simple messaging interface much like email that allows them to compose and send the message. There is, however, a locally stored list of allowed destination names and all priority choices available to that user. Thus, the software enforces the access restrictions for users using the stand alone software that would otherwise be enforced by the software on the server.

In this way, even if the Internet is down, or the server is down, the user has the ability to directly connect to the RDS encoder.

While various embodiments of the present invention have been illustrated herein in detail, it should be apparent that modifications and adaptations to those embodiments may occur to those skilled in the art without departing from the scope of the present invention as set forth in the following claims.

What is claimed is:

1. Apparatus for accessing an RDS encoder for sending alert messages to one or more radios, comprising a server connected to the internet for receiving information from a user over the internet, the server controlling the generation and sending of alert messages as ODA data groups to selected sets of said radios via said RDS encoder.

2. Apparatus of claim 1 in which the ODA data groups are sent to the RDS encoder via one of an internet communication link or a satellite communication link, or a direct connection.

3. Apparatus of claim 1 in which the server will automatically cancel the alert messages as specified by the user.

4. Apparatus of claim 1 in which the information received from a user includes information for managing the address space for the delivery of messages to selected groups of users.

5. Apparatus of claim 4 in which the address space can be managed to control addresses of radios selectively associated with messages by criteria comprising destination group, company, individuals or radio identification.

6. Apparatus of claim 4 in which the server transmits alert message over the RDS encoder and also to destinations other than alert radios.

7. Apparatus of claim 6 in which the destinations other than alert radios comprise at least one of cellular telephones, email destinations, SMS destinations and text messaging destinations.

8. Apparatus of claim 1 in which the information received from a user comprises information for changing system information about the user's radio.

9. Apparatus of claim 1 comprising a user interface, accessible over the internet by which a user can selectively manage network information, manage user information, send a custom generated message, send a predefined message, program user radios and scan CAP files available over the internet for terms indicating alert information that might affect users in at least one destination group.

10. Apparatus of claim 1 in which access to functionality of the server is dependent upon permissions associated with a user's log on identification.

11. A method for accessing an RDS encoder for sending alert messages to one or more radios, comprising the steps of:
a. receiving information over the internet,
b. addressing an alert message to one or more sets of said radios in response to said information,
b. forming said alert message as one or more ODA data groups, and
c. sending said ODA data groups to an RDS encoder.

12. The method of claim 11 comprising the further step of transmitting the ODA data groups using an FM transmitter.

13. The method of claim 12 comprising the further step of sending a cancellation message to said radios based on said information.

14. The method of claim 11 in which the step of addressing an alert message comprises the steps of selecting addresses to which the alert message is to be directed using at least one criterion selected from the group comprising (1) membership in a destination group, (2) being employed by a company, (3) identified individuals and (4) identification of a radio.

15. The method of claim 11 further comprising the step of sending the alert message to a cell phone, an email destination, an SMS destination and text messaging destination substantially contemporaneously with sending the alert message to the RDS encoder.

16. The method of claim 11 in which the step of receiving information comprises accessing selected CAP files and extracting information from said CAP files for alert information that might affect users in an area serviced by the RDS encoder.

17. A computer program product, comprising:
a. a storage medium; and
b. computer controlling instructions, stored on said medium, for receiving information over the internet, addressing an alert message to one or more sets of radios in response to said information, forming said alert message as one or more ODA data groups, and sending said ODA data groups to an RDS encoder.

18. The computer program product of claim 17 in which the computer controlling instructions further comprise instructions for sending a cancellation message to said radios based on said information.

19. The computer program product of claim 17 in which the computer controlling instructions further comprise instructions for sending an alert message to a cell phone, an email destination, an SMS destination and text messaging destination substantially contemporaneously with sending the alert message to the RDS encoder.

20. The computer program product of claim 17 in which the computer controlling instructions further comprise instructions for selecting addresses to which the alert message is to be directed using at least one criterion selected from the group comprising (1) membership in a destination group, (2) being employed by a company, (3) identified individuals and (4) identification of a radio.

21. The computer program product of claim 17 in which the computer controlling instructions further comprise instructions for linking predefined message/destination pairs such that sending a certain predefined message to a certain destination will cause one or more other predefined messages to be sent to specific destinations.

22. The computer program product of claim 17 in which the computer controlling instructions further comprise instructions for linking a destination of one customer to a destination of another customer such that the one customer can send a message to a certain destination and cause the message to also be sent to another destination of a different customer.

23. A method of directly accessing an RDS encoder comprising:
using an input screen display on a user terminal for input of a desired message to be transmitted over the RDS encoder and
sending the desired message to the RDS encoder using at least one of a wired modem, a wireless modem and a serial port.

24. A computer program product comprising:
a. a computer readable medium;
b. instructions stored on said computer readable medium for controlling a computer to
1. display an input screen on a display of the computer;
2. allow a user to input a desired message, using the input screen, to be transmitted over an RDS encoder; and
3. sending the desired message to the RDS encoder using at least one of a wired modem, a wireless modem and a serial port.

25. The computer program product of claim 24 in which the instructions further comprise instructing restricting the privileges available to a user based on a users privileges on a remote server, without accessing the server.

26. A dual tuner clock radio device, capable of receiving, decoding and acting upon ODA data groups received from an RDS encoder over an emergency warning station using a first tuner and that can function as a normal clock radio which can listen to any FM station while concurrently monitoring data from the emergency warning station using the second tuner.

27. The dual tuner clock radio device of claim 26 equipped to activate at least one notification device in at least one of a plurality of modes in response to receipt of a warning alert from said emergency warning station.
